(19) United States
(12) Patent Application Publication
(10) Pub. No.: US 2012/0147279 A1
(43) Pub. Date: Jun. 14, 2012

(54) PROJECTION DISPLAY APPARATUS

(75) Inventors: Atsushi KOYANAGI, Fukushima (JP); Teppei Konishi, Fukushima (JP); Hiroshi Kumai, Fukushima (JP)

(73) Assignee: Asahi Glass Company, Limited, Chiyoda-ku (JP)

(21) Appl. No.: 13/305,213

(22) Filed: Nov. 28, 2011

(30) Foreign Application Priority Data
Dec. 10, 2010 (JP) 2010-275790

(51) Int. Cl. G02F 1/1335

(52) U.S. Cl. 349/5

(57) ABSTRACT

A projection display device includes: a light source unit including at least one light source configured to emit coherent light; an image light generation unit configured to generate an image light by modulating light emitted by the light source unit; a projection unit configured to project the image light; and a liquid crystal element, disposed in an optical path between the light source unit and the image light generation unit, configured to temporally change a phase and/or polarization of transmitted light, wherein: the liquid crystal element at least includes transparent electrodes respectively provided on opposing faces of a plurality of transparent substrates; a liquid crystal layer including smectic phase liquid crystal showing spontaneous polarization under voltage application is sandwiched between the transparent electrodes; and an AC voltage is applied to the liquid crystal layer through the transparent electrodes.

### BACKGROUND

1. Field of the Invention

The present invention relates to a projection display device, and more particularly, it relates to a projection display device using a light source with coherence.

2. Description of the Related Art

As a light source for a display device that displays a projected image on a screen such as a data projector or a rear-projection television, a ultra-high pressure (UHP) mercury lamp has been conventionally used, and use of a laser has been proposed from the viewpoint of the lifetime of the light source. Furthermore, since the UHP lamp has a spectrum with a broad wavelength band in the vicinity of 645 nm, that is, a red wavelength region, owing to its characteristics, a combined light source using a laser as a red light source and UHP lamps for blue and green wavelength regions has been also proposed.

In a projection display device using a laser as a light source, however, granularity speckle noise derived from the coherence of laser is caused in a projected image, resulting in a problem that the quality of the projected image is degraded.

Therefore, as a projection display device with reduced speckle noise, a non-speckle display device in which a diffuser element provided in an optical path of light emitted from a laser corresponding to a light source is rotated/vibrated at a higher speed than a visually recognizable speed has been proposed (in JP-A-H06-208089). When the diffuser element is thus mechanically operated, the laser light having coherency is brought into a state where the phase is spatially shifted, thereby eliminating the speckle noise.

Alternatively, as an device for avoiding the speckle noise without the mechanical vibrating operation of the diffuser element or the like, an image display device in which a composite liquid crystal film is provided in an optical path of light emitted from a semiconductor laser diode so as to change the phase of incident light by applying a voltage to the composite liquid crystal film has been proposed (in JP-A-2005-338520).

Similarly, as an device for avoiding the speckle noise, an optical device in which a voltage is applied to an electro-optical element having an electrode formed in a ferroelectric substrate (crystal) including irregular domain inversion of lithium niobate so as to temporally change the refractive index of the ferroelectric substrate has been proposed (in International Publication No. 99/049354 pamphlet).

In the structure of the non-speckle display device of JP-A-H06-208089, however, a driver device including a motor or a coil is necessary for rotating or vibrating the diffuser element, which not only increases the size of the device but also causes a problem of reliability due to occurrence of noise through the mechanical vibration.

Furthermore, according to JP-A-2005-338520, the refractivity anisotropy of liquid crystal used in a liquid crystal lens (i.e., the composite liquid crystal film) is utilized for modulating the phase of transmitted light in accordance with the applied voltage, and therefore, in the case where, for example, nematic liquid crystal is used, it is necessary to increase the quantity of the phase change (i.e., a retardation value, which is obtained as a product of the “refractivity anisotropy” and the “thickness of the liquid crystal film”) for sufficiently reduce the speckle noise. In this case, it is necessary to increase the thickness of the liquid crystal film for increasing the quantity of the phase change. Furthermore, there arises another problem that a response speed is lowered as the thickness of the liquid crystal film is increased. Furthermore, there is a problem that a response speed sufficient for modulating the phase at a higher speed than a visually recognizable speed may not be attained by using the nematic liquid crystal.

Moreover, since the phase of transmitted light is modulated in accordance with the voltage applied to the ferroelectric substrate also in International Publication No. 99/049354 pamphlet, it is necessary to increase the thickness of the ferroelectric substrate similarly for increasing the quantity of the phase change, and furthermore, it is necessary to apply an AC voltage controlled to have a DC voltage superimposed thereon to the domain irregularly formed in the ferroelectric substrate. In addition, since inorganic crystal is used, there arises another problem of difficulty in fabrication through processing or the like.

### SUMMARY

The present invention was achieved for solving the aforementioned problems of the conventional techniques, and an object of the invention is providing a highly reliable projection display device in which speckle noise may be stably reduced by employing a simple structure in the case where a light source with coherence is used.

According to an aspect of the invention, there is provided a projection display device including: a light source unit including at least one light source configured to emit coherent light; an image light generation unit configured to generate an image light by modulating light emitted by the light source unit; a projection unit configured to project the image light; and a liquid crystal element, disposed in an optical path between the light source unit and the image light generation unit, configured to temporally change a phase and/or polarization of transmitted light, wherein: the liquid crystal element at least includes transparent electrodes respectively provided on opposing faces of a plurality of transparent substrates; a liquid crystal layer including smectic phase liquid crystal showing spontaneous polarization under voltage application is sandwiched between the transparent electrodes; and an AC voltage is applied to the liquid crystal layer through the transparent electrodes.

In the aspect of the invention, an interface of the liquid crystal layer may be not subjected to an alignment treatment.

In the aspect of the invention, an alignment film for aligning the liquid crystal may be provided on an interface of the liquid crystal layer.

In the aspect of the invention, the alignment film may have at least two or more patterns different in an alignment direction.

In the aspect of the invention, one or more light scattering elements for emitting light obtained by scattering incident light may be provided in an optical path between the light source unit and the liquid crystal element and/or in an optical path between the liquid crystal element and the image light generation unit.

In the aspect of the invention, a focusing lens for focusing scattered light may be provided in an optical path between the liquid crystal element and the image light generation unit.

In the aspect of the invention, the liquid crystal may be chiral smectic C phase liquid crystal.

In the aspect of the invention, the liquid crystal may have a phase transition series of Iso-N(*)-SmC*.

In the aspect of the invention, the liquid crystal element may include a plurality of stacked liquid crystal layers as the liquid crystal layer.

In the aspect of the invention, a phase of the AC voltage to be applied to a first liquid crystal layer out of the plurality of liquid crystal layers may be different from a phase of the AC voltage to be applied to a second liquid crystal layer.

In the aspect of the invention, the voltage to be applied to the liquid crystal layer may be 0.01 to 25 Vrms/μm.

In the aspect of the invention, the voltage to be applied to the liquid crystal layer may have a frequency of 70 to 2000 Hz.

In the aspect of the invention, each of the transparent electrodes of the liquid crystal element may include a plurality of regions, and voltages to be applied to the plurality of regions may be different in a voltage value and/or a frequency.

The present invention provides a projection display device exhibiting an effect to stably reduce speckle noise simply in the case where a light source with coherence is used.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a conceptual diagram illustrating the structure of a projection display device according to Embodiment 1 of the invention;

FIG. 2 is a schematic cross-sectional view of a liquid crystal element;

FIG. 3A is a schematic diagram illustrating a scattering state of light entering an optical element having a scattering property, and FIG. 3B is a graph of a full width at half maximum of transmitted light;

FIG. 4 is a conceptual diagram illustrating the structure of a projection display device according to Embodiment 2 of the invention; and

FIG. 5 is a conceptual diagram illustrating the structure of a projection display device according to Embodiment 3 of the invention.

### DETAILED DESCRIPTION OF THE INVENTION

### Embodiment 1

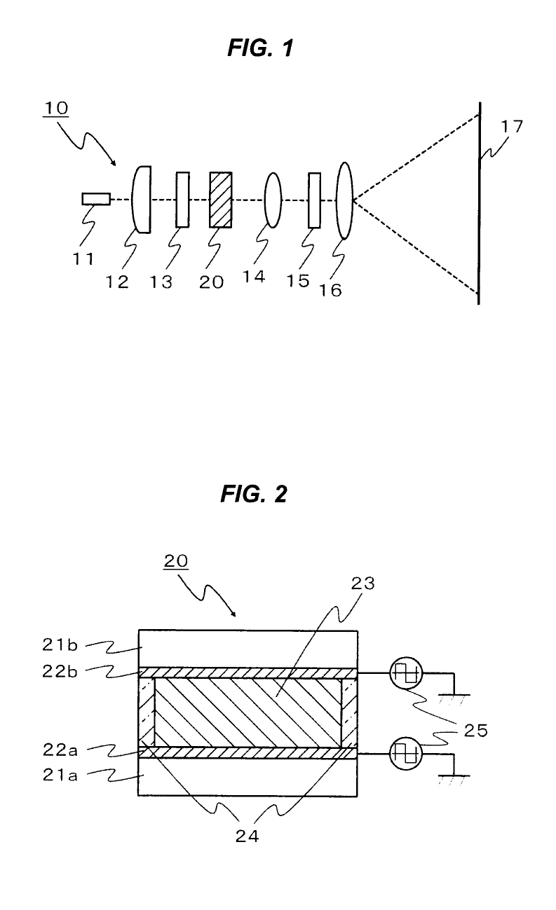

FIG. 1 is a schematic diagram illustrating an example of the structure of a projection display device 10 according to this embodiment. Light emitted from at least one laser 11, such as a semiconductor laser or a solid state laser, used as a light source for emitting light with coherence (hereinafter referred to as “coherent light”) corresponding to light emitting means is condensed by a collimator lens 12 into substantially parallel lights before passing through a polarizer 13. It is noted that a light source including at least one laser is designated as a light source unit as a whole. When, for example, a semiconductor laser is used as the laser 11, it emits linear polarized light and the polarization direction may be varied or changed with time due to fabrication variation or temperature change in use environment. The polarizer 13 is used for making such a polarization state of the light constant.

The light having passed through the polarizer 13 is temporally changed by a liquid crystal element 20 in its phase and/or polarization in passing therethrough, so that light with averaged spatial light interference may be emitted. Herein, temporal change in the phase and/or polarization corresponds to a case where phase change φ₁ and/or polarization of light passing through the liquid crystal element 20 at time T₁ is different from phase change φ₂ and/or polarization of light passing through the liquid crystal element 20 at time T₂ (T₁≠T₂) when coherent light enters the liquid crystal element 20. The light having passed through the liquid crystal element 20 and having been temporally averaged in its phase and/or polarization is focused by a focusing lens 14 onto a spatial light modulator 15 corresponding to an image light generation unit. Incidentally, the light emitted from the laser 11 may be light that is scattered by guiding with a fiber or the like, and in this case, the projection display device 10 may employ a structure using neither the collimator lens 12 nor the polarizer 13.

Furthermore, as the spatial light modulator 15, a transmission liquid crystal panel may be typically used, and a reflection liquid crystal panel or a digital micro-mirror device (DMD) may be used. Alternatively, in the case where a transmission liquid crystal panel or a reflection liquid crystal panel is used as the spatial light modulator 15, the polarization is preferably made even for suppressing change with time of the incident light. At this point, the direction of the linear polarized light entering the liquid crystal element 20 may accord with the direction of the ordinary light refractive index or extraordinary light refractive index of liquid crystal molecules of the liquid crystal element 20, or a polarization conversing element not shown may be provided in an optical path between the liquid crystal element 20 and the spatial light modulator 15. The light thus having entered the spatial light modulator 15 is modulated in accordance with a picture signal, and the resultant modulated light is projected by a projection lens 16 onto a screen 17 or the like. An element (a lens) having a function to project light like this projection lens is designated as a projection part. Incidentally, the light source may employ a structure using merely one laser source, a structure including a plurality of laser sources for respectively emitting light of different wavelengths, or a structure using a combination of a light source not emitting coherent light and a laser source emitting coherent light.

Next, the specific structure of the liquid crystal element 20 used in the projection display device of this embodiment will be described with reference to a schematic cross-sectional view of FIG. 2. The liquid crystal element 20 includes transparent electrodes 22a and 22b respectively formed on one face of each of two transparent substrates 21a and 21b, which are disposed substantially in parallel to each other with their faces having the transparent electrodes opposing each other, and it also includes a liquid crystal layer 23 formed by filling liquid crystal between the transparent substrates. It is noted that each of the transparent substrates 21a and 21b may be a flat substrate or have concave and convex thereon, and that fine particles or the like capable of scattering light may be included in the liquid crystal layer 23. The liquid crystal element 20 further includes a sealing material 24 for sealing the liquid crystal in the peripheries of the transparent substrates 21a and 21b. Furthermore, wiring for supplying voltages to the transparent electrodes 22a and 22b are provided and connected to a power source 25 for applying an AC voltage to the liquid crystal layer 23. Moreover, either of or both of an insulating film (not shown) used for the purpose of preventing a short-circuit between the transparent electrodes and an alignment film used for the purpose of controlling prescribed alignment may be provided on each of the transparent substrates 21a and 21b.

Each of the transparent substrates 21a and 21b may be made of, for example, an acrylic resin, an epoxy resin, a vinyl chloride resin, polycarbonate or the like, and a glass substrate is suitably used from the viewpoint of durability and the like. As each of the transparent electrodes 22a and 22b, a metal film of Au, Al or the like may be used, and a film of ITO, SnO₃ or the like is suitably used because such a film is superior to the metal film in light transmittance and mechanical durability.

The sealing material 24 is used for preventing the liquid crystal of the liquid crystal layer 23 from leaking out of a space between the transparent substrates 21a and 21b and is provided on the periphery of an optical effective region to be secured. The material for the sealing material 24 is preferably a resin adhesive such as an epoxy adhesive or an acrylic adhesive from the viewpoint of handling, and a material cured by heating or irradiating with UV may be used. Furthermore, a spacer of glass fiber or the like may be mixed by several % for attaining a desired cell gap.

Incidentally, an antireflection coating not shown is suitably provided on the face of each of the transparent substrates 21a and 21b not in contact with the liquid crystal layer 23 because utilization efficiency of the light is thus improved. Such an antireflection coating may be a dielectric multilayered film, a thin film with a thickness of wavelength order or the like, and any of other films may be used. Such a film may be formed by deposition method, sputtering method or the like, and any of other methods may be employed.

In the case where an insulating film is formed, for example, a method of vacuum forming the film by sputtering or the like or a method of chemically forming the film by sol-gel process may be employed with an inorganic material such as SiO₂, ZrO₂ or TiO₂ used. Incidentally, the alignment of the liquid crystal molecules may be set by allowing the liquid crystal to come into contact with the surface of an alignment film formed by, for example, a method of rubbing a film of polyimide, polyvinyl alcohol (PVA) or the like, a method of causing photo-alignment through irradiation of a chemical substance having a photoreactive functional group with UV light polarized in a specific direction, a method of obliquely depositing SiO or the like, or a method of irradiating diamond-like carbon or the like with ion beams. The insulating film and the alignment film are preferably used because they may prevent a short-circuit otherwise caused between the transparent electrodes or prevent image sticking in the liquid crystal layer otherwise caused when it is driven for a long period of time.

As described above, the liquid crystal element 20 used in the projection display device of this invention has a function to cause change with time of a speckle pattern by temporally changing the phase and/or polarization of incident coherent light and allowing the resultant light to pass therethrough. An image thus projected is observed with speckle noise reduced. As the liquid crystal used in the liquid crystal layer 23 of this liquid crystal element 20, smectic phase liquid crystal with spontaneous polarization is used, so as to characteristically employ a quick phase modulation mode induced by quickly inverting the direction of the spontaneous polarization caused by applying an AC voltage to the liquid crystal layer 23. In the phase modulation mode employed in this invention, the phase and/or polarization of transmitted light may be quickly modulated in response to the frequency of the AC voltage differently from a system using the nematic liquid crystal and employed in a display or the like. Therefore, when this characteristic of the invention is employed, the speckle noise may be effectively reduced by modulating the phase and/or polarization more at a higher speed than a visually recognizable speed.

Moreover, in the case where the liquid crystal element 20 used in the projection display device of this invention employs a structure not using an alignment film for controlling the alignment of the liquid crystal molecules, the liquid crystal molecules are randomly oriented along various directions when the AC voltage is not applied to the liquid crystal layer 23 (hereinafter referred to as the “no-voltage application state”). Therefore, when the AC voltage is applied to the liquid crystal layer 23 (hereinafter referred to as the “voltage application state”), the coherent light is quickly modulated by the liquid crystal element 20, so that the phase and/or polarization of the transmitted light may be also provided in a temporally random pattern. Accordingly, the coherence of the coherent light emitted from the laser may be more effectively reduced, so as to effectively reduce the speckle noise.

The liquid crystal element 20 is not limited to one described above and may include an alignment film. In the structure where the liquid crystal element 20 includes an alignment film, the liquid crystal molecules may be oriented substantially uniaxially at the no-voltage application state. In the structure not including an alignment film, the transmitted light may be scattered by a grain boundary derived from a focal conic texture peculiar to the smectic liquid crystal. On the other hand, when the structure including an alignment film is employed, the scattering of the transmitted light may be suppressed in some cases, so as to improve the utilization efficiency of the light described later. Incidentally, even when the structure where the liquid crystal element 20 includes an alignment film is employed, the phase and/or polarization of the transmitted light may be quickly modulated by applying an AC voltage to the liquid crystal element 20, so as to attain the effect to reduce the speckle noise. In this manner, the liquid crystal element 20 may employ the structure including an alignment film or the structure not including an alignment film, which may be appropriately set in accordance with a desired effect.

Furthermore, in employing the structure where the liquid crystal element 20 includes an alignment film, an alignment region where the liquid crystal molecules are oriented substantially uniaxially may have at least two or more different patterns. In this case, not only the light transmitted by the liquid crystal element 20 is quickly modulated at the voltage application state but also the phase and/or polarization of the transmitted light may be modulated in two or more phase and/or polarization patterns in accordance with the alignment regions, and hence, the speckle noise may be effectively reduced. It is noted that the utilization efficiency of the light may be improved also in this case because the liquid crystal molecules are oriented substantially uniaxially in each of the regions. At this point, the plane pattern of the regions may be, for example, a striped pattern, a checked pattern or a concentric pattern, to which the pattern is not limited.

Moreover, the projection display device 10 may include, in the optical path between the laser 11 and the liquid crystal element 20, a multiple-light generation unit not shown for changing the light entering the liquid crystal element 20 into a plurality of convergent lights or parallel lights having substantially the same optical axis and a small numerical aperture NA. In this case, the liquid crystal layer 23 temporally modulates the phases and/or polarizations of these plural lights generated by the multiple-light generation unit, so as to make the liquid crystal layer 23 produce pseudo plural light sources different from one another in the phase and/or polarization. As the focusing lens 14, it is possible to use a lens having a plurality of lens structures for efficiently incorporating light of the plural light sources different in the phase and/or polarization emitted from the liquid crystal layer 23 and for changing these incident light into parallel or convergent lights. In this case, the focusing lens 14 is preferably, for example, an integrated array type focusing lens, which is herein defined as an emitting side focusing lens array. The structures, the focal distances and the distances from the liquid crystal layer 23 of respective lenses included in the emitting side focusing lens array may be appropriately designed so as to realize desired functions.

Furthermore, the multiple-light generation unit (not shown) for changing the light entering the liquid crystal element 20 into plurality of lights may be, for example, an integrated array type focusing lens, which is herein defined as an incident side focusing lens array. The incident side focusing lens array may be an array in which focusing lenses each in a rectangular shape with an aspect ratio of, for example, 9:16 are arranged in a matrix of 16×9 and which has a plane, substantially perpendicular to the optical axis, in an external square shape. Now, application of such a structure will be described.

The light emitted from the laser 11 is changed into substantially parallel lights before entering the liquid crystal layer 23 disposed in the vicinity of the focal point where the light is focused by the multiple-light generation unit (i.e., the incident side focusing lens array). At this point, each of the lenses included in the incident side focusing lens array is preferably a lens with a numerical aperture NAᵢₙ of 0.1 or less that generates a converged light with a comparatively long focal distance. In this case, since the pseudo light sources in number of 16×9 are produced in the liquid crystal layer 23, rectangular focusing lens with an aspect ratio of 9:16 may be suitably arranged in the matrix of 16×9 correspondingly to these pseudo light sources in the emitting side focusing lens array.

At this point, in the case where the incident side focusing lens array and the liquid crystal element 20 are provided with air disposed therebetween, the numerical aperture NAₒᵤₜ of each focusing lens of the emitting side focusing lens array is in a relationship of NAₒᵤₜ=sine with a half angle θ of an acceptance angle. Therefore, the focal distance of the emitting side focusing lens array is set so as to attain the numerical aperture NAₒᵤₜ in a relationship of NAₒᵤₜ>NAᵢₙ and capable of efficiently incorporating the light having been temporally modulated in the phase and/or polarization by the liquid crystal layer 23. Specifically, the numerical aperture NAₒᵤₜ is preferably set to 0.26 to 0.64 corresponding to an angle θ of 15° (corresponding to an acceptance angle of 30°) to 40° (corresponding to an acceptance angle of 80°). Incidentally, even when the incident side focusing lens array and the liquid crystal element 20 are provided with a transparent medium such as an adhesive with a refractive index n>1 disposed therebetween, the numerical aperture NAₒᵤₜ is set so that the emitting side focusing lens array may attain a desired focal distance.

Furthermore, a single focusing lens not shown for covering the whole emitting light may be provided on the emitting side of the emitting side focusing lens array. In this case, principal rays of the respective focusing lenses of the emitting side focusing lens array may be focused onto the spatial light modulator 15, and thus the lights may be efficiently focused onto the spatial light modulator 15. Moreover, when the emitting side focusing lens array is what is called a fry eye lens including a pair of convex lens arrays described later, a spatial light intensity distribution of the emitting light is averaged in the emitting side focusing lens array, and hence, the light intensity distribution of light output from the spatial light modulator 15 may be homogenized in a projected image thus obtained.

Although the liquid crystal layer 23 of the liquid crystal element 20 is formed as a single layer, this does not limit the invention but two or more liquid crystal layers may be provided to be stacked so that a voltage may be applied to each of the layers. In this case, the temporal change in the phase and/or polarization of the incident light may be further increased by the plural liquid crystal layers, resulting in attaining an effect to largely reduce the speckle noise. Furthermore, when the plural liquid crystal layers are provided to overlap, the amplitude, the frequency and the phase of the AC voltage to be applied to each liquid crystal layer may be arbitrarily set. For example, when the liquid crystal element 20 is driven by the power source 25 with AC voltages in different phases applied to the respective liquid crystal layers, the time interval of the temporal change in the phase and/or polarization of the incident light is reduced, so as to more quickly change the speckle pattern. Moreover, the phase of the AC voltage to be applied is preferably changed at an equal time interval because the effect to reduce the speckle noise is thus increased.

Moreover, even in the case where the liquid crystal layer 23 of the liquid crystal element 20 is formed as a single layer, the liquid crystal layer 23 may include, in an effective region where the light enters, two or more regions where the voltage may be applied to the liquid crystal, so that the voltage may be applied to the respective regions independently. At this point, the liquid crystal element 20 may be driven by the power source 25 by a method in which one, two or all of the amplitude, the frequency and the phase of the AC voltage to be applied to the liquid crystal of each region are different among the two or more regions. In this case, in the whole light passing through the liquid crystal element 20, the phase and/or polarization of light passing through each region may be independently modulated temporally, and hence, the speckle noise may be more effectively reduced. At this point, a plane pattern of the regions may be a striped pattern, a checked pattern, a concentric pattern or the like, to which the pattern is not limited.

Moreover, each of the transparent substrates 21a and 21b used in the liquid crystal element 20 may be a substrate having a concave and convex structure, so that the light may be scattered by the concave and convex structure. In this case, the phase and/or polarization of the light passing through the liquid crystal element 20 may be effectively changed through microscopic refractive index modulation caused by movement of the liquid crystal molecules on the interface between the transparent substrate and the liquid crystal. As the shape of concave and convex, a pattern of a grid shape, a striped shape or the like may be employed, to which the shape is not limited.

The liquid crystal layer 23 used in the liquid crystal element 20 may include fine particles or the like capable of scattering light, so as to scatter the light by the fine particles. The phase and/or polarization of the light passing through the liquid crystal element 20 may be effectively changed through microscopic refractive index modulation caused by movement of the liquid crystal molecules on the interface between the fine particles and the liquid crystal. The material for the fine particles to be thus used may be SiO₂, plastic or the like, and the shape may be a spherical shape or a needle shape, but the material and the shape are not limited to them.

Next, the material and the mode for the liquid crystal layer 23 will be specifically described. A material for exhibiting a phase change mode and/or a polarization modulation mode where the phase and/or polarization may be quickly modulated in accordance with an applied voltage is, for example, a ferroelectric liquid crystal composition such as chiral smectic (SmC*) phase liquid crystal having spontaneous polarization, and the chiral SmC* phase liquid crystal has a helical pitch structure. When the chiral SmC* phase liquid crystal is filled between two substrates opposing each other and provided with an alignment film, for example, the following two modes are achieved: One is a surface stabilized ferroelectric liquid crystal (SSFLC) mode obtained by filling the liquid crystal in a cell gap smaller than the helical pitch in which ferroelectricity is shown at the no-voltage application state; and the other is a deformed helix ferroelectric liquid crystal (DHFLC) mode obtained by filling the liquid crystal in a cell gap (width) sufficiently larger than the helical pitch in which the liquid crystal is aligned for allowing the helical structure of the chiral SmC* phase liquid crystal to remain.

In the DHFLC mode, the direction of the spontaneous polarization is rotated along the helical cycle, and hence is cancelled. Accordingly, the ferroelectricity is apparently cancelled in an initial state (i.e., at the no-voltage application state). On the other hand, at the voltage application state, the helical structure is continuously distorted and the spontaneous polarization is shown in this mode. The liquid crystal layer 23 of the liquid crystal element 20 of the projection display device of this invention may employ any of these modes as far as the phase and/or polarization of the incident light may be quickly modulated in accordance with the applied voltage.

Alternatively, as modes utilizing the spontaneous polarization characteristic similarly to the DHFLC mode, a twisted FLC mode or a τ-Vmin mode may be employed.

Furthermore, anti-ferroelectric liquid crystal obtained by causing some alignment in chiral smectic C_{A} (SmC_{A}*) phase liquid crystal by using a substrate provided with an alignment film through an alignment film treatment may be utilized. Also in this case, since the direction of the spontaneous polarization is random in the layer, the ferroelectricity is apparently cancelled at the no-voltage application state, but phase transition to the ferroelectric phase is caused by applying a voltage, and hence the spontaneous polarization is shown in this mode. Alternatively, an electroclinic mode using chiral smectic A (SmA*) phase liquid crystal may be utilized.

Apart from the chiral smectic C phase liquid crystal, examples of hexatic phase liquid crystal having a phase structure inclined from a layer normal are SmI phase liquid crystal and SmF phase liquid crystal. Furthermore, phases where the SmI phase liquid crystal and the SmF phase liquid crystal show three-dimensional order are crystal J, G, K, H phase liquid crystal, and these liquid crystal phases including the SmI phase liquid crystal and the SmF phase liquid crystal are known to show ferroelectricity by introducing an asymmetric point and may be similarly utilized.

In this manner, a liquid crystal composition having the smectic phase with spontaneous polarization is used for the liquid crystal layer 23, but there is no need for the liquid crystal composition to show the ferroelectricity at the no-voltage application state and any liquid crystal composition capable of showing the spontaneous polarization under desired voltage application is regarded to belong to this category of the liquid crystal composition. Alternatively, a liquid crystal/polymer composite or crystal obtained through polymer stabilization or the like may be similarly utilized. Furthermore, a side chain liquid crystalline polymer with ferroelectricity may be similarly utilized. In this case, since the liquid crystal phase is stabilized through the polymer stabilization or molecular weight increase, an effect to widely stabilize the range of a working temperature may be thus attained.

The value of the spontaneous polarization (Ps) of the smectic phase liquid crystal composition used for the liquid crystal layer 23 is not particularly specified in both the upper and lower limits, and in order to temporally modulate the phase and/or polarization of incident coherent light, high responsibility to an external electric field is preferred, and hence, a composition with a larger absolute value of the spontaneous polarization is preferred in general. Furthermore, an effect to reduce a drive voltage may be attained by a composition with a larger value of the spontaneous polarization, and hence, the absolute value of the spontaneous polarization is preferably 10 nC/cm² or more, more preferably 20 nC/cm² or more and further preferably 40 nC/cm² or more at room temperature (25° C.)

Next, the temperature characteristic of the spontaneous polarization of the smectic phase liquid crystal composition used for the liquid crystal layer 23 will be described. In general, a ferroelectric liquid crystal composition obtained by developing the chiral smectic C phase is an indirect type ferroelectric substance in which rod liquid crystal molecules show the spontaneous polarization in accordance with the inclination from the layer direction of the liquid crystal layer, and the value of the spontaneous polarization is determined depending upon molecular polarization and the angle of the inclination. In many cases, a liquid crystal composition showing the smectic C phase undergoes transition to the smectic A phase at a temperature higher than the temperature range of the smectic C phase, and the phase transition caused at this point is second order phase transition, and the angle of the inclination on the basis of the thickness direction of the liquid crystal layer gets gradually closer to 0° as the temperature increases, and hence, the spontaneous polarization also gets closer to 0 as the temperature increases.

On the other hand, phase transition from the smectic C phase to the (chiral) nematic phase is first order phase transition and the angle of the inclination is abruptly changed from a finite value to 0 (zero) at a transition point, and hence, the spontaneous polarization is not 0 but keeps a prescribed value in the vicinity of the phase transition temperature. Specifically, among chiral smectic phase liquid crystal compositions, as compared with a liquid crystal composition having Iso-N(*)-SmA-SmC*, that is, phase transition series, a liquid crystal composition having Iso-N(*)-SmC* free from the smectic A phase shows spontaneous polarization not 0 at a temperature in the vicinity of the upper limit temperature for showing the smectic C phase, and hence, the phase and/or polarization may be quickly modulated temporally in incident coherent light by applying an AC voltage.

At this point, the liquid crystal composition having

Iso-N(*)-SmA-SmC* is superior at the alignment property against an alignment film as compared with the liquid crystal composition having Iso-N(*)-SmC*. Furthermore, when the liquid crystal element used in the projection display device of this invention employs the structure not using an alignment film, any of these liquid crystal compositions may be used, and the liquid crystal composition having Iso-N(*)-SmC* is preferred because it shows the spontaneous polarization at higher temperature not 0 as described above.

Next, the thickness of the liquid crystal layer 23 (i.e., the cell gap) is preferably 1 μm or more for securing a sufficient quantity of phase modulation and/or large change of polarization. Furthermore, for reducing the speckle noise, it is more effective to increase the quantity of the phase and/or polarization temporally changed in the incident coherent light. Therefore, the cell gap of the liquid crystal layer 23 is preferably larger in general, but since it is necessary to increase the voltage to be applied as the thickness is increased, the cell gap is preferably 200 μm or less. Moreover, in order to allow the helical structure to definitely remain and to attain an effect to suppress the voltage to be applied, the cell gap (the thickness) is more preferably 5 μm or more and 100 μm or less.

The frequency of the AC voltage to be applied to the liquid crystal layer 23 is preferably 70 to 2000 Hz. Also, in order to cause, in the incident light, sufficiently large temporally change in the phase and/or polarization and to lower the voltage to be applied necessarily for reducing the speckle noise through low frequency drive, the liquid crystal layer 23 is driven preferably at a frequency of approximately 70 to 1000 Hz. Furthermore, in driving the liquid crystal layer at a frequency of this range, a necessary voltage is 0.01 to 25 Vrms/μm, preferably 0.02 to 20 Vrms/μm and more preferably approximately 0.03 to 15 Vrms/μm.

Next, utilization efficiency of the light of the liquid crystal element 20 will be described. The utilization efficiency of the light of the liquid crystal element 20 is defined, as described later in detail, as a product obtained by multiplying transmittance of the liquid crystal element 20 by a proportion of the amount of the light incorporated by a prescribed optical system out of the whole amount of the light passing through the liquid crystal element 20. In the case where the liquid crystal element 20 includes an alignment film, the scattering of the transmitted light may be suppressed as described above, and thus, the utilization efficiency of the light is improved. The utilization efficiency of the light may be considered dividedly with respect to a straight light component passing straight through the liquid crystal layer 23 and a scattered light component different from the straight light component, and when the proportion of the latter scattered light component is larger, it may be a factor to lower utilization efficiency of the light. At this point, the amount of cumulative light related to the scattering angle of scattered light and the utilization efficiency of the light will now be defined.

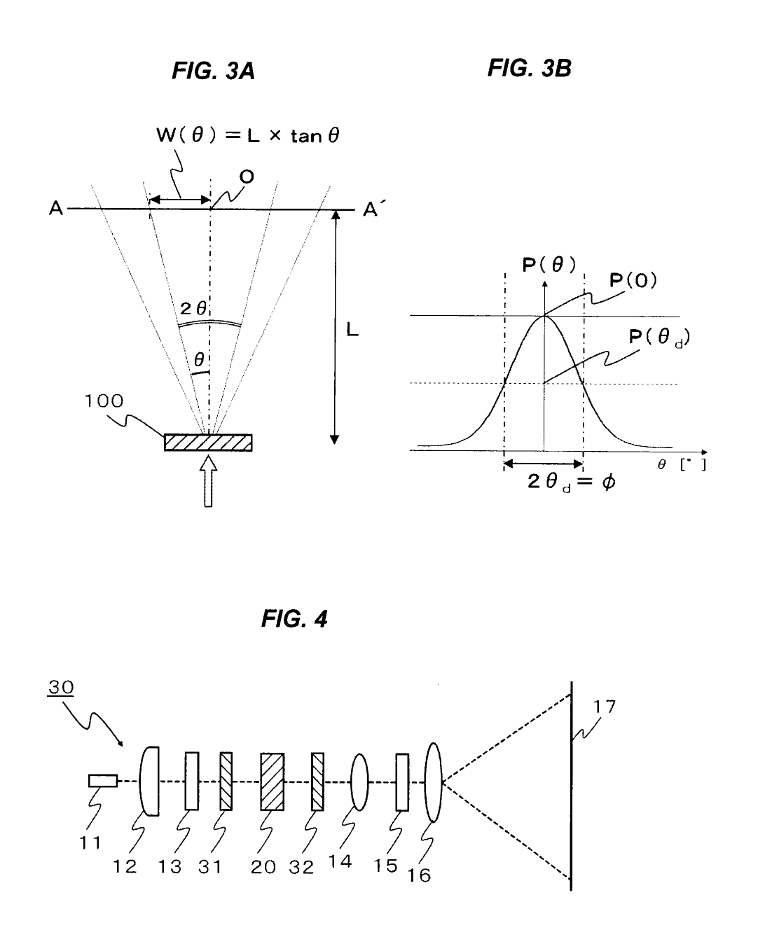

FIG. 3A is a schematic diagram illustrating light passing through an optical element 100 obtained when straight (laser) light enters the optical element 100 having a scattering property. Specifically, FIG. 3A illustrates a straight line A-A′ included in a plane perpendicular to the optical axis at a distance L sufficiently away from the straight forward direction (=optical axis) of the incident light. It is herein assumed that an intersection point between the straight line A-A′ and the optical axis is a reference point O. It is also assumed that an angle between the optical axis and a beam of light scatteringly passing through the optical element 100 is an angle θ. Assuming that a distance from the reference point O to an intersection point between the light scattered at the angle θ and the straight line A-A′ is expressed as W(θ), the scattered light irradiates a position of W(θ)=L×tan θ on the straight line A-A′. At this point, it is assumed that the light intensity attained in a position irradiated on the straight line A-A′ is expressed as P(θ) with the angle θ used as a variable.

It is herein assumed that a light intensity distribution of the light passing through the optical element 100, namely, the relationship between the angle θ and the light intensity P(θ), shows a normal distribution, a scattering angle φ may be defined by an angle satisfying a full width at half maximum (FWHM). Furthermore, FIG. 3B is a diagram of a distribution obtained when the intensity distribution of the light passing through the optical element 100 is a normal distribution. At this point, the light intensity P(θ) obtained in a position away from the reference point O by W(θ)=L×tan θ in FIG. 3A may be deduced on the basis of the normal distribution of FIG. 3B. Also, with respect to the intensity P(θ), when a half of a value of intensity P(0), namely, the angle θ satisfying P(θ)=P(0)/2, is assumed as an angle θ_{d}, the full width at half maximum is expressed as 2θ_{d}. Since the scattering angle φ is also defined as the angle satisfying the full width at half maximum (FWHM) as described above, the scattering angle φ=2θ_{d}. Incidentally, the scattering angle φ corresponds to an angle at which a proportion of the light within the angle 2θ (=2φ) in an irradiated region on the plane including the line A-A′ is approximately 95% when θ=φ in FIG. 3A.

However, in the case where the light passing through the liquid crystal element 20 may be considered dividedly as the straight light component substantially according with the straight forward direction of the incident light and the scattered light component other than the straight light component as in the liquid crystal element 20, the light intensity does not always show a normal distribution. Therefore, in considering the utilization efficiency of the light passing through the liquid crystal element 20, it may not be defined on the basis of the scattering angle φ alone, and hence, the utilization efficiency of the light will be considered on the basis of the amount of cumulative light defined as follows:

First, the amount of cumulative light is defined as light within an angle 2θ in FIG. 3A. In other words, since θ is an arbitrary value, as the value of θ is increased, the amount of cumulative light is increased. Also in this case, the amount of cumulative light generally includes, regardless of the value of θ, the light of the straight light component transmitted in the straight forward direction of the incident light. In other words, even when θ=0, the amount of cumulative light attained at this point may be regarded as the straight light component passing straight through the liquid crystal element 20. When the value of θ is increased beyond 0, the amount of cumulative light is increased, and this increase may be regarded as the scattered light component. Specifically, the straight light component corresponds to a component of light passing through the liquid crystal element 20 along a direction substantially according with the proceeding direction of the incident light. For example, when a parallel beam of φ2 mm is allowed to enter the liquid crystal element 20, out of the whole light passing through the liquid crystal element 20, a prescribed amount of light is obtained in a region of φ2 mm on the optical axis regardless of the distance, and this prescribed amount of light may be regarded as the straight light component.

Next, the utilization efficiency of the light attained at this point will be examined. When the light having passed through the liquid crystal element 20 is regarded to be used within the acceptance angle ψ corresponding to a critical angle of the optical system, light within an angle larger than the acceptance angle ψ is not used by the optical system. It is noted that the acceptance angle ψ is an angle expressed as a whole angle. Accordingly, utilization efficiency of the light may be defined as a product obtained by multiplying the transmittance of the liquid crystal element 20 by a proportion of light within the acceptance angle ψ out of the whole light passing though the liquid crystal element 20. Therefore, for increasing the utilization efficiency of the light, it is preferred that the transmittance of the liquid crystal element 20 is high, it is preferred that the acceptance angle ψ is large, and it is more preferred that the acceptance angle ψ is larger than the scattering angle φ.

Furthermore, in an optical system, the acceptance angle ψ is given within the range of 10° to 60° in many cases. Therefore, for improving the utilization efficiency of the light of the liquid crystal element 20, the transmittance of the liquid crystal element 20 is preferably 70% or more, more preferably 80% or more and much more preferably 90% or more. In addition, the amount of cumulative light within the acceptance angle ψ of the optical system is preferably 70% or more of the total amount of light output from the liquid crystal element 20, more preferably 80% or more of the total amount of light output from the liquid crystal element 20 and much more preferably 90% or more of the total amount of light output from the liquid crystal element 20. Moreover, the acceptance angle ψ of an optical system having a smaller value is advantageous for downsizing the whole device or the like, and hence, the angle 2θ of the liquid crystal element 20 for providing necessary and prescribed light within the acceptance angle ψ of the optical system is preferably 60° or less, more preferably 20° or less and much more preferably 10° or less.

Next, speckle contrast Cₛ used as an index of the speckle noise will be described. The speckle contrast is, as represented by Expression (3), a ratio of a standard deviation σ of the brightness of pixels represented by Expression (1) to an average of the brightness of the pixels represented by Expression (2). In these expressions, N indicates the total number of pixels, Iₙ indicates the brightness of each pixel, and Iₐᵥᵣ indicates an average of the brightness of all the pixels. When the speckle contrast Cₛ has a smaller value, speckle noise observed in a projected image is reduced. Herein, the projection display device including the liquid crystal element of the present invention will be evaluated on the basis of the speckle contrast thus obtained. It is noted that the speckle contrast may be 12% or less, preferably 10% or less and more preferably 8% or less.

$$\begin{matrix}[ Expression 1 ] & \\ σ = \sqrt{\frac{{\sum }_{n = 1}^{N} {\vert {I}_{avr} - {I}_{n} \vert}^{2}}{N}} & ( 1 ) \\ [ Expression 2 ] & \\ {I}_{avr} = \frac{{\sum }_{n = 1}^{N} {I}_{n}}{N} & ( 2 ) \\ [ Expression 3 ] & \\ {C}_{s} = \frac{σ}{{I}_{avr}} & ( 3 )\end{matrix}$$

### Embodiment 2

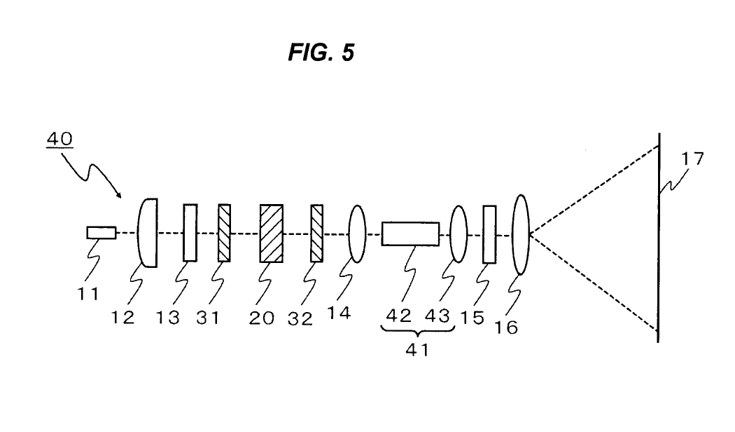

FIG. 4 is a schematic diagram illustrating the structure of a projection display device 30 according to this embodiment, in which like reference numerals are used to refer to like optical elements and the like used in the projection display device 10 so as to avoid repetition of the description. The projection display device 30 includes, in the optical path between the laser 11 corresponding to the light source and the screen 17 for displaying an image thereon, a light scattering element 31 disposed in an optical path between the polarizer 13 and the liquid crystal element 20 and a light scattering element 32 disposed in an optical path between the liquid crystal element 20 and the focusing lens 14. Both of the light scattering elements 31 and 32 may be provided, merely one of the light scattering elements 31 and 32 may be provided, or one or both of the light scattering elements 31 and 32 may be stacked on the liquid crystal element 20.

Each of the light scattering elements 31 and 32 is a static scattering element having prescribed scattering power, and for example, a scattering plate with scattering power not changed with time may be used, to which the scattering element is not limited. Any element capable of homogeneously scattering incident light may be used, and for example, the light scattering element may be made of polymer dispersed liquid crystal or cholesteric liquid crystal. Furthermore, the scattering angle may be given on the basis of the definition described in Embodiment 1, and the upper limit of the scattering angle of the light scattering elements 31 and 32 is preferably 30° or less, more preferably 10° or less and much more preferably 5° or less. When at least one light scattering element (i.e., the light scattering element 31 and/or the light scattering element 32) is thus used together with the liquid crystal element 20 as in the projection display device 30 of this embodiment, the light having been temporally modulated in the phase and/or polarization by the liquid crystal element 20 is complicatedly overlapped by the light scattering element (s), and hence, the speckle noise reducing effect to be attained may be increased as compared with the case where the liquid crystal element 20 alone is used.

### Embodiment 3

FIG. 5 is a schematic diagram illustrating the structure of a projection display device 40 according to this embodiment, in which like reference numerals are used to refer to like optical elements and the like used in the projection display device 30 so as to avoid repetition of the description. The projection display device 40 includes, in an optical path between the focusing lens 14 and the spatial light modulator 15, light homogenizing means 41 so that the light having been temporally modulated in the phase and/or polarization by passing through the liquid crystal element 20 may irradiate a region for forming an image in the spatial light modulator 15 with homogenous light intensity. Although the projection display device 40 includes the light scattering elements 31 and 32, these elements may be omitted as in the projection display device 10 of Embodiment 1.

The light homogenizing means 41 may be a combination of a rod integrator 42 and a focusing lens 43. For example, the rod integrator 42 includes a glass block in which at least a light emitting face is similar figure to a face of the spatial light modulator 15 where an image is formed (hereinafter referred to as the “image forming face”), and light entering the glass block is guided to be totally reflected on its side face before emitting. Furthermore, in order to reduce a loss of light leaked through a side face of the rod integrator 42, a reflecting film or a protection film may be formed on the side face. The focusing lens 43 is provided so as to have a numerical aperture and a focal distance set so that the light output from the rod integrator may form an image on the image forming face of the spatial light modulator 15. Incidentally, in the case where the scattering angle of the light proceeding after being temporally modulated by the liquid crystal element 20 in the phase and/or polarization is small, there is no need to provide the focusing lens 43. Specifically, in such a case, the light output from an end of the rod integrator 42 may directly enter the spatial light modulator 15.

Alternative light homogenizing means 41 may be a combination of a pair of convex lens arrays in a similar figure to the image forming face of the spatial light modulator 15 and a focusing lens. It is noted that a convex lens array includes two-dimensionally arranged unit lenses each defined as a lens of a minimum unit. At this point, it is possible to use what is called a fry eye lens where unit lenses of one convex lens array are arranged so that light emitted from unit lenses of the other convex lens array may form an image on the image forming face of the spatial light modulator 15. In this case, the focusing lens is provided in a light emitting part of the convex lens array so as to cancel the shift in the optical axis among the respective unit lenses and make their optical axes accord with one another on the image forming face of the spatial light modulator 15.

Moreover, in the case where the spatial light modulator 15 has polarization dependence, when light entering the light homogenizing means 41 is not homogenous in the polarization, a loss of light to be used may be reduced by converting the incident light into light with specific linear polarization. As a structure to be employed for this purpose, for example, polarizing beam splitters arranged in the shape of an array and a space division half-wave plate having a half-wave plate in a specific area in the whole region where the light enters are provided in an optical path between the pair of convex lens arrays, and thus, the incident light may be converted into light of specific linear polarization before emitting. In such a structure, the spatial light modulator 15 preferably includes a liquid crystal element or the like exhibiting polarization dependence against incident light because the utilization efficiency of the light may be thus particularly improved.

### EXAMPLES

### Example 1

In this example, a method for fabricating a liquid crystal element will be first described. On one face of each of two transparent substrates of quartz glass with a thickness of approximately 0.525 mm, an ITO with sheet resistance of approximately 75Ω/□ to be used as a transparent electrode was formed, and an insulating film including SiO₂ as a principal component was formed thereon in a thickness of approximately 50 nm. The pair of transparent substrates was made to oppose each other with their faces having the insulating films opposing each other, and the peripheries of the transparent substrates were sealed with a sealing material including a spacer, so as to provide a cell gap of approximately 50 μm. It is noted that the ITO and the insulating film were not formed in a portion where the sealing material was provided.

Next, a smectic phase liquid crystal composition, that is, Felix 017/100a (manufactured by AZ electronic materials) was filled through a filling port provided in the sealing material but not shown, and the filling port was sealed with an end-sealing material, resulting in fabricating a liquid crystal element. At this point, the alignment of liquid crystal molecules was random because the interface of the insulating film was not yet subjected to an alignment treatment. Furthermore, the liquid crystal element is provided with an electrode drawing portion for obtaining a structure for applying a voltage to the sandwiched liquid crystal layer, and may be connected to an external power source through the electrode drawing portion. Incidentally, the smectic phase liquid crystal composition exhibits ferroelectricity, the specific resistance value of the ferroelectric liquid crystal composition is 2.6×10¹² Ω.cm, and the value of the spontaneous polarization is nC/cm² at room temperature (25° C.)

A voltage for attaining the phase modulation mode and/or polarization modulation mode was applied to the actually fabricated liquid crystal element, so as to confirm the speckle reducing effect. Specifically, in the projection display device illustrated in FIG. 5, a solid state laser for emitting coherent light of a wavelength of approximately 532 nm was used as the light source 11, and a diffuser panel with a scattering angle of 5° was used as the light scattering element 31. Then, an image projected on the screen 17 with a rectangular AC voltage of approximately 60 Vrms and 100 Hz applied to the fabricated liquid crystal element was photographed with a digital camera. For photographing the image with the digital camera, a square area with approximately 1.5 cm sides at the center of the screen was photographed at an angle substantially vertical to the screen face. In 40,000 pixels in rows of 200 pixels and columns of 200 pixels, the brightness of the respective pixels was analyzed in 256 levels on a 0-255 scale, so as to measure speckle contrast Cₛ attained when the average Iₐᵥᵣ of the brightness of the pixels was 110.

The speckle contrast Cₛ thus obtained was approximately 10.8%, and thus, the speckle reducing effect was confirmed. Furthermore, in this case, the amount of cumulative light within the angle 2θ=20° was 80%, and thus, high utilization efficiency of the light may be attained by employing the phase modulation mode and/or polarization modulation mode.

### Example 2

In Example 2, two liquid crystal elements fabricated in the same manner as in Example 1 were stacked along the light proceeding direction. Then, a rectangular AC voltage of approximately 60 Vrms and 100 Hz was applied to the fabricated liquid crystal elements with the phase shifted between the two liquid crystal elements by 90 deg., and the speckle contrast Cₛ attained when the average brightness Iₐᵥᵣ was 110 was measured under the same conditions as in Example 1.

The speckle contrast Cₛ attained in this case was approximately 8.1%, and a larger speckle reducing effect was confirmed when the rectangular AC voltage was applied to the plural layers of the liquid crystal elements with the phase shifted therebetween. It is noted that the amount of cumulative light within the angle 2θ=20° attained in this case was 55%.

### Example 3

In Example 3, in the projection display device of FIG. 5 similarly to Example 1, a diffuser panel with a scattering angle of 10° was used as the light scattering element 32 to be stacked on a liquid crystal element fabricated in the same manner as in Example 1. Then, a rectangular AC voltage of approximately 60 Vrms and 100 Hz was applied to the fabricated liquid crystal element, and the speckle contrast Cₛ attained when the average brightness Iₐᵥᵣ was 110 was measured in the same manner as in Example 1.

The speckle contrast Cₛ attained in this case was approximately 7.9%, and the amount of cumulative light within the angle 2θ=20° attained in this case was 76%. When a diffuser panel with a scattering angle of 10° is stacked on a liquid crystal element in this manner, a loss of the amount of cumulative light within the angle of 2θ=20° may be suppressed so as to improve the utilization efficiency of the light as well as to improve the speckle reducing effect.

### Example 4

In Example 4, a liquid crystal element was fabricated in the same manner as in Example 1 except that the insulating film formed in Example 1 was replaced with a polyimide film and that an alignment film obtained through an alignment treatment performed along uniaxial direction by rubbing was formed. Furthermore, the cell gap was approximately 17 μm. The thus fabricated liquid crystal element was stacked in two layers. Furthermore, a diffuser panel with a scattering angle of 5° was used as each of the light scattering elements 31 and 32, so as to be further stacked in front of and behind the two stacked liquid crystal elements. Then, a rectangular AC voltage of approximately 30 Vrms and 100 Hz was applied to the fabricated liquid crystal elements with the phase shifted between the two liquid crystal elements by 90 deg., and the speckle contrast Cₛ attained when the average brightness Iₐᵥᵣ was 110 was measured under the same conditions as in Example 1.

The speckle contrast Cₛ attained in this case was approximately 7.8%, and the amount of cumulative light within the angle 2θ=20° attained in this case was 90%. It is understood from this result that the amount of cumulative light within the angle 2θ=20° may be largely increased and high utilization efficiency of the light may be attained by forming an alignment film for uniaxially orienting liquid crystal molecules and by further stacking light scattering elements.

### Example 5

In Example 5, three liquid crystal elements each including an alignment film were fabricated in the same manner as in Example 4. The thus fabricated three liquid crystal elements were stacked, and a diffuser panel with a scattering angle of 10° was further stacked as the light scattering element 32 on the liquid crystal elements. Then, a rectangular AC voltage of approximately 30 Vrms and 100 Hz was applied to the fabricated liquid crystal elements with the phase shifted between the liquid crystal element of the first layer and the liquid crystal element of the second layer by 60 deg. and between the liquid crystal element of the first layer and the liquid crystal element of the third layer by 120 deg., and the speckle contrast Cₛ attained when the average brightness Iₐᵥᵣ was 110 was measured under the same conditions as in Example 1.

The speckle contrast Cₛ attained in this case was approximately 7%, and the amount of cumulative light within the angle 2θ=20° attained in this case was 80%. In this manner, when the phase of a rectangular AC voltage to be applied to the respective liquid crystal elements is shifted among the liquid crystal elements stacked in three layers, a high speckle reducing effect and high utilization efficiency of the light may be attained.

As described so far, the present invention provides a projection display device exhibiting an effect to simply and stably reduce speckle noise in the case where a light source with coherence is used.

What is claimed is:

1. A projection display device comprising:
a light source unit including at least one light source configured to emit coherent light;
an image light generation unit configured to generate an image light by modulating light emitted by the light source unit;
a projection unit configured to project the image light; and
a liquid crystal element, disposed in an optical path between the light source unit and the image light generation unit, configured to temporally change a phase and/or polarization of transmitted light, wherein:
the liquid crystal element at least includes transparent electrodes respectively provided on opposing faces of a plurality of transparent substrates;
a liquid crystal layer including smectic phase liquid crystal showing spontaneous polarization under voltage application is sandwiched between the transparent electrodes; and
an AC voltage is applied to the liquid crystal layer through the transparent electrodes.

2. The projection display device according to claim 1, wherein
an interface of the liquid crystal layer is not subjected to an alignment treatment.

3. The projection display device according to claim 1, wherein
an alignment film for aligning the liquid crystal is provided on an interface of the liquid crystal layer.

4. The projection display device according to claim 3, wherein
the alignment film has at least two or more patterns different in an alignment direction.

5. The projection display device according to claim 1, wherein
one or more light scattering elements for emitting light obtained by scattering incident light are provided in an optical path between the light source unit and the liquid crystal element and/or in an optical path between the liquid crystal element and the image light generation unit.

6. The projection display device according to claim 1, wherein
a focusing lens for focusing scattered light is provided in an optical path between the liquid crystal element and the image light generation unit.

7. The projection display device according to claim 1, wherein
the liquid crystal is chiral smectic C phase liquid crystal.

8. The projection display device according to claim 1, wherein
the liquid crystal has a phase transition series of Iso-N(*)-SmC*.

9. The projection display device according to claim 1, wherein
the liquid crystal element includes a plurality of stacked liquid crystal layers as the liquid crystal layer.

10. The projection display device according to claim 1, wherein
a phase of the AC voltage to be applied to a first liquid crystal layer out of the plurality of liquid crystal layers is different from a phase of the AC voltage to be applied to a second liquid crystal layer.

11. The projection display device according to claim 1, wherein
the voltage to be applied to the liquid crystal layer is 0.01 to 25 Vrms/μm.

12. The projection display device according to claim 1, wherein
the voltage to be applied to the liquid crystal layer has a frequency of 70 to 2000 Hz.

13. The projection display device according to claim 1, wherein
each of the transparent electrodes of the liquid crystal element includes a plurality of regions, and voltages to be applied to the plurality of regions are different in a voltage value and/or a frequency.
